(19) United States
(12) Patent Application Publication
(10) Pub. No.: US 2004/0092022 A1
(43) Pub. Date: May 13, 2004

(54) Measuring device for detecting temperature-dependent measure values

(76) Inventor: Albert Bosch, Steyl (NL)

Correspondence Address: FISH & RICHARDSON P.C., 5000 BANK ONE CENTER, 1717 MAIN STREET, DALLAS, TX, 75201, US

(21) Appl. No.: 10/416,781

(22) PCT Filed: Nov. 14, 2001
(86) PCT No.: PCT/EP01/13178

(30) Foreign Application Priority Data
Nov. 15, 2000 (DE) 200-19-360.0

(51) Int. Cl. G01N 31/22

(52) U.S. Cl. 436/1; 422/56

(57) ABSTRACT

The invention is a measuring device for detecting temperature-dependent measured values or temperature-dependent combinations of physical influencing factors, in particular for measuring temperatures in sterilizing apparatus, with at least one measuring mechanism.

### BACKGROUND

Clothes, surgical instruments and other objects that need sterilization are sterilized in the sterilization chambers. During steam sterilization, steam is injected into the sterilization chamber at the beginning of the sterilization process. Since the steam does not mix with the air that is still in the sterilization chamber, the flow of steam has to be periodically interrupted and the air that is still in the sterilization chamber, or the non-condensable gases that might be contained in the steam, must be removed via a vacuum pump. The process is repeated several times.

As soon as there is no more air in the sterilization chamber, the 134° C. hot saturated steam is conveyed at 2 bar into the sterilization chamber for a period of about three minutes, with the saturated steam condensing on the object to be actually sterilized and releasing condensation heat. This triggers the actual sterilization.

Subsequently the sterilization chamber is opened to let the steam escape. At the same time a vacuum is drawn, reducing the boiling point of water to about 20° C. After about 10 minutes the objects to be sterilized are dry and the sterilization process is finished.

To make sure that the sterilization process is proceeding well, the pressure is measured, among other things. If needed, so-called chemical indicators are placed between the objects to be sterilized, which change color once certain time and temperature parameters as well as a certain degree of humidity are reached. If there is a need to monitor whether the vacuum pumps are generating a sufficient vacuum, the chemical indicators are placed in a hollow container with an opening to which a barrier such as a fitted canal may be attached, which in turn is placed between the objects to be sterilized. A change in color can only occur if the steam penetrates into the hollow container, which in turn makes it necessary beforehand to create a vacuum in the hollow container.

However, at the same time the temperature must also be monitored continuously, for which purpose there is a thermoelement at the pour spout of the sterilization chamber. Yet this measured value does not permit any firm conclusions as to whether this temperature prevails also inside the objects to be sterilized, e.g., stacked clothing. Moreover, especially thermoelements do not permit the determination whether the measured temperature is due to the radiant heat or—which is crucially important—due to the condensation heat, because only the released condensation heat assures a satisfactory sterilization.

### SUMMARY

It is the object of the invention to improve the measuring device in such a way that the measured temperature has indeed been generated by the released condensation heat. This object is solved by increasing, in order to reduce the effect of short-term temperature influences on the measured value, the heat capacity of the measuring device through an additional heat-absorbing material that is in heat-conducting contact with the measure zone of the measuring device, at least in certain areas. In doing so the higher heat capacity of the total, consisting of the measuring device and the additional material, replaces the lower heat capacity of the measuring device alone, making it possible to absorb a larger heat volume, i.e., a longer influence with a certain temperature difference is required before there is a change in the measured value. Based on its good heat conductivity and the additional heat capacity, the additional material absorbs the heat and thereby ensures that lesser energy inputs, e.g., by the radiant heat, change the temperature of the measuring device only slightly.

In the process the additional heat capacity may result from a larger amount of an additional material with a smaller specific heat capacity or from a smaller amount of an additional material with a correspondingly higher specific heat capacity.

For example, if the measuring device is heated for a short time only by the radiant heat or non-condensable gases, the heat is directly absorbed by the material, which can absorb much heat. However, the latter is not heated very much because of the higher mass. Therefore the measuring device cools off again. Only when substantial amounts of heat are released by the condensation of the saturated steam, heating not only the measuring device but also the material, can one be sure that the rise in temperature registered at that point is caused by the released condensation heat. The measuring device allows, for example, the temperature to be measured directly.

The material may for example be in the form of a square and may be arranged on the side and/or the front of the measuring device.

In another embodiment the material may surround the measuring device at least in certain areas.

To great advantage the material may be formed into a shell preferentially open at the end and mounted on the measuring device in the area of the measure zone.

The material may contain copper, aluminum and/or lead. However, other materials can be used as well, such as metals, preferentially stainless steel or metal alloys of plastics.

In one embodiment the measuring device may be in the form of a chemical indicator. This allows for the measurement of temperature-dependent measured values or temperature-dependent combinations of physical influencing factors that permit drawing a conclusion about the temperature prevailing in the sterilization chamber. Since the chemical indicators are, among other things, independent of time and temperature, such an example of an embodiment ensures under all circumstances that a possible optical change in color has taken place at a precisely specified temperature. Since the material is in contact with the chemical indicator, it is certain that the temperature necessary for changing the color is generated by the released condensation heat.

The measuring device may be a thermoelement, but other electrical measuring mechanisms such as infrared thermometers are also quite feasible.

The measuring device may be connected to a measured value storage device and power supply, making it unnecessary to connect the measuring device itself to an evaluation equipment located e.g., outside the sterilization chamber.

An interface may be provided to good purpose, in particular for data transfer. At the start-up of the sterilization process the measuring device is placed between the objects to be sterilized. After the end of the sterilization process the measuring device is removed from the sterilization chamber and the data recorded on the measured value storage device are transmitted via the interface e.g., to a computer.

In addition a counter for the number of measurements already completed may be provided to good purpose. This is required above all if the law specifies maintenance service to be carried out after a certain number of measurements. If the number of measurements specified by law is exceeded, an optical or acoustic warning signal may sound, as an example.

At least the measuring device may be placed in a hollow container having at least one opening.

A canal in the form of a tube or hose may be fitted to the opening. Such a hollow container with a fitted canal simulates surgical instruments with similar tubular elements, making it possible to ensure in this way that a satisfactory vacuum is generated during the sterilization process. When generating a vacuum in the sterilization chamber, fast the air is also removed from the canal and the hollow container. Only after a vacuum has been generated in the hollow container, the vacuum thus generated allows the steam to be drawn through the canal into the hollow container. If there is a chemical indicator in the hollow container, the operation of the sterilization chamber can be checked.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a lateral view of a measuring device according to the invention with material arranged on the side,

FIG. 2 a lateral view of a measuring device in which the material is in the form of a shell mounted on the end, and

FIG. 3 a partial cross section through a hollow container with a fitted canal and the measuring device located therein.

### DETAILED DESCRIPTION

In all illustrations the same reference numerals are used for the same or similar elements.

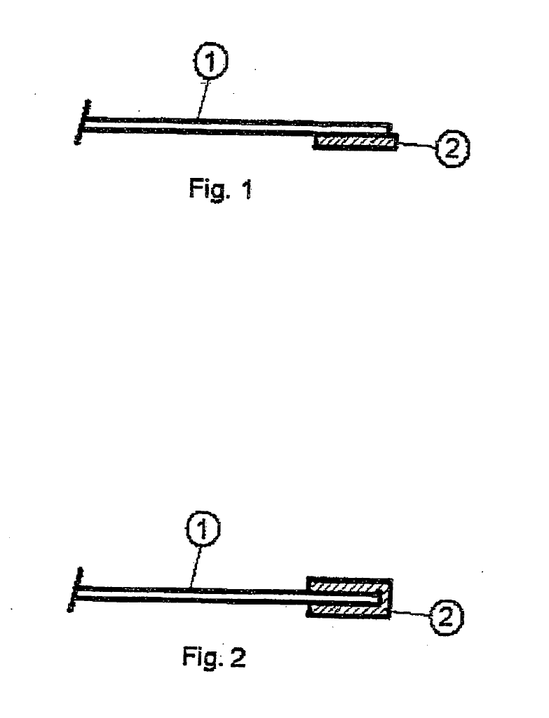

FIG. 1 shows a measuring device 1 at which end a material 2 is placed that is in heat-conducting contact with the measuring device 1. In the example of the embodiment shown, the material 2 is arranged on the side of the measuring device 1.

The material 2 is adapted to the measuring device 1 in terms of properties and mass in such a way that the total, consisting of measuring device 1 and additional material 2, shows a higher heat capacity, thus requiring a larger heat volume, i.e., a longer influence at a certain temperature difference, in order to bring about a change in measured value. If the measuring device 1 is heated for a short time e.g., by the radiant heat, the heat is dispersed directly into the material 2. As a result of the larger mass of material 2, it does not heat up so much. As a result of the heat extracted by material 2, the measuring device 1 cools off in tandem, with the result that the short-term increased temperature in the measuring device 1 caused by the radiant heat is not measured. However, if condensation heat, formed by the condensation of the saturated steam, is released, the material 2 heats up accordingly. The temperature measured in such a way corresponds then precisely to the increase in temperature caused by the condensation heat.

The measuring device 1 in the example of an embodiment that is shown is in the form of a thermoelement connected to a display or evaluation equipment that is not shown. However, other measuring devices such as a mercury thermometer or infrared thermometer are conceivable.

In the example of the embodiment shown in FIG. 2 the material 2 has the form of a shell closed at the end, which is mounted at the end of the measuring device I.

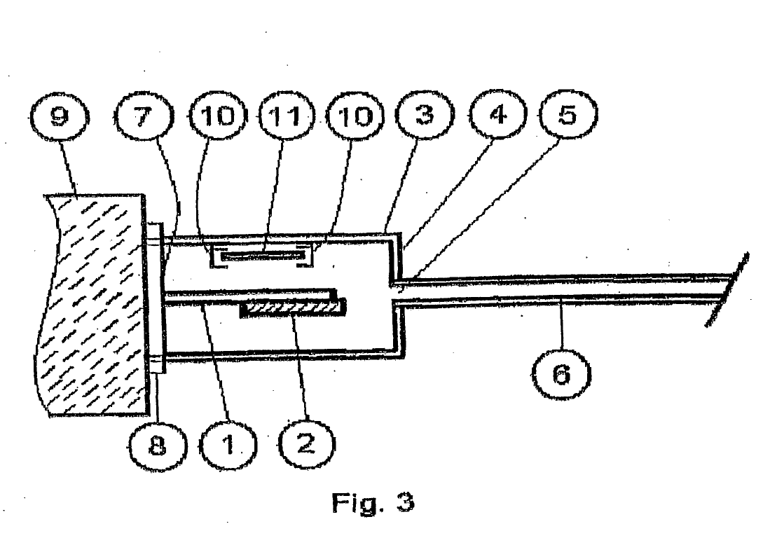

In FIG. 3 the measuring device 1 is placed into a hollow container 3 with the material 2 arranged at the end. The hollow container 3 has an opening 5 in a frontal face 4, with a tubular canal 6 being fitted to the opening 5. The other frontal face 7 is in the form of a screw plug 8 to which a measured value storage device and power supply 9 are attached in the example of the embodiment shown here. From the measured value storage device and power supply 9 the measuring device 1 with the heat-conducting material 2 protrudes into the hollow container 3 through the screw plug 8.

The measured value storage device and power supply 9 is heat-resistant and may therefore also be located inside the sterilization chamber during the sterilization process. After the sterilization process the data recorded in the measured value storage device and power supply 9 may be transmitted via an interface to an evaluation equipment located outside the sterilization chamber. However, it is also conceivable that the measured data are sent to a recipient outside the sterilization chamber via radio.

To open the hollow container 3 the screw plug 8 is removed, which gives thereby access to the measuring device 1. Subsequently the hollow container 3 is again locked via the screw plug 8.

In the hollow container 3 there is also a retaining device 10, which serves to hold e.g., a chemical indicator 11. This chemical indicator 11 changes color at a certain humidity level, with certain temperature and time parameters having to be present simultaneously.

The hollow container 3 with the fitted canal 6 serves for the simulation of, for example, a surgical instrument with a long, tubular structure that is to be sterilized in a sterilization chamber. The way the hollow container 3 and the canal 6 are arranged allows one to control whether the vacuum pumps of the sterilization chamber are generating a satisfactory vacuum since only in the presence of a satisfactory vacuum can steam penetrate into the interior of the hollow container 3 via the canal 6 and can make the chemical indicator 11 change color.

However, the measuring device 1 may also be connected for example via a cable to an evaluation and display unit placed preferably outside the sterilization chamber. In that case there would be no need for the measured value storage device and power supply 9.

A number of embodiments of the invention have been described. Nevertheless, it will be understood that various modifications may be made without departing from the spirit and scope of the invention. Accordingly, other embodiments are within the scope of the following claims.

What is claimed is:

1. Measuring device to detect temperature-dependent measured values or temperature-dependent combinations of physical influencing factors, in particular for measuring temperatures in sterilizers, with at least one measuring device (1), characterized by the fact that, in order to reduce the effect of short-term temperature influences on the measured value, the heat capacity of the measuring device (1) is increased by an additional heat-absorbing material (2) being in heat-conducting contact with the measure zone of the measuring device (1) at least in certain areas.

2. Measuring device according to claim 1, characterized by the fact that the material (2) is placed on the side of the measuring device (1).

3. Measuring device according to claim 1 or 2, characterized by the fact that the material (2) is placed in front of the measuring device (1).

4. Measuring device according to one of the claims 1 to 3, characterized by the fact that the material (2) surrounds the measuring device (1) at least in certain areas.

5. Measuring device according to claim 4, characterized by the fact that the material (2) is in the form of a shell preferably closed at one end.

6. Measuring device according to one of the claims 1 to 5, characterized by the fact that the material (2) contains copper.

7. Measuring device according to one of the claims 1 to 6, characterized by the fact that the material (2) contains aluminum.

8. Measuring device according to one of the claims 1 to 7, characterized by the fact that the material (2) contains lead.

9. Measuring device according to one of the claims 1 to 8, characterized by the fact that the material (2) is a metal, preferably stainless steel.

10. Measuring device according to one of the claims 1 to 9, characterized by the fact that the measuring device (1) is in the form of a chemical indicator (11).

11. Measuring device according to one of the claims 1 to 9, characterized by the fact that the measuring device (1) is a thermoelement.

12. Measuring device according to claim I 1, characterized by the fact that the measuring device (1) is connected to a measured value storage device and power supply (9).

13. Measuring device according to claim 12, characterized by the fact that an interface, in particular for data transfer, is provided.

14. Measuring device according to one of the claims 11 to 13, characterized by the fact that in addition a counter for counting the number of the completed measurements is provided.

15. Measuring device according to one of the claims 1 to 14, characterized by the fact that at least the measuring device (1)is placed in a hollow container (3) having at least one opening (5).

16. Measuring device according to claim 15, characterized by the fact that a canal (6) in the form of a tube or hose is fitted to the opening (5).
